(19) United States
(12) Patent Application Publication
(10) Pub. No.: US 2019/0283740 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Akihiro Toda, Wako-shi (JP); Yugo Ueda, Wako-shi (JP)

(21) Appl. No.: 16/296,270

(22) Filed: Mar. 8, 2019

(30) Foreign Application Priority Data
Mar. 15, 2018 (JP) 2018-047993

(51) Int. Cl. B60W 30/09; G06F 16/29; G05D 1/00; G05D 1/02; B60W 10/20

(52) U.S. Cl. CPC B60W 30/09; G06F 16/29; G05D 1/0088; G05D 1/0289; B60W 2710/20; B60W 2550/14; B60W 2550/22; B60W 2720/10; B60W 10/20

(57) ABSTRACT

A vehicle control device includes a recognizer that is configured to recognize a surrounding situation of a subject vehicle, and a driving controller that is configured to control a speed and steering of the subject vehicle according to map information including a travel route of the subject vehicle and a recognition result by the recognizer.

The driving controller is configured to cause the control of the speed or the steering of the subject vehicle to be different between a case where a predetermined point at which a median strip is broken is recognized by the recognizer and a case where the predetermined point is not recognized by the recognizer, while the subject vehicle is traveling in a section in which a lane is separated by the median strip extending in an extending direction of a road indicated by the map information.

### CROSS-REFERENCE TO RELATED APPLICATION

This application is based upon and claims the benefit of priority from Japanese Patent Application No. 2018-047993, filed Mar. 15, 2018, the entire content of which is incorporated herein by reference.

### BACKGROUND

### Field of the Invention

The present invention relates to a vehicle control device, a vehicle control method, and a storage medium.

### Description of Related Art

In recent years, researches are being conducted on automatically controlling driving of a vehicle (hereinafter, referred to as automatic driving). On the other hand, a technology of transmitting predetermined road information from a device to another vehicle in a case where the device provided in a protective block or a protective body installed on a road detects a vehicle is known (refer to, for example, Japanese Unexamined Patent Application, First Publication No. H11-288498).

### SUMMARY

However, in the related art, it has not been sufficiently studied that in a case where there is another vehicle having a high probability of entering a subject lane on which a subject vehicle is traveling, the subject lane causes to travel on an assumption that the other vehicle enters the own lane. As a result, in some cases, it was not possible to sufficiently cope with a change of a surrounding situation.

An aspect of the present invention has been made in consideration of such circumstances, and an object of the aspect of the present invention is to provide a vehicle control device, a vehicle control method, and a storage medium capable of coping with a change of a surrounding situation of a subject vehicle.

A vehicle control device, a vehicle control method, and a storage medium according to the present invention adopt the following constitutions.

According to an aspect (1) of the present invention, a vehicle control device includes a recognizer that is configured to recognize a surrounding situation of a subject vehicle, and a driving controller that is configured to control the speed and steering of the subject vehicle according to map information including a travel route of the subject vehicle and a recognition result by the recognizer. The driving controller is configured to cause the control of the speed or the steering of the subject vehicle to be different between a case where a predetermined point at which a median strip is broken is recognized by the recognizer and a case where the predetermined point is not recognized by the recognizer, while the subject vehicle is traveling in a section in which a lane is separated by the median strip extending in an extending direction of a road indicated by the map information.

According to an aspect of (2), in the vehicle control device according to the aspect of (1), in a case that the recognizer recognizes that one or more oncoming vehicles are present on an opposite lane adjacent to a subject lane through the median strip and it is recognized that a specific oncoming vehicle displaying an intention to change the lane from the opposite lane to the subject lane at the predetermined point among the one or more oncoming vehicles is present by the recognizer, the driving controller is configured to cause the control of the speed or the steering of the subject vehicle to be different.

According to an aspect of (3), in the vehicle control device according to an aspect of (1) or (2), in a case that the recognizer recognizes that an intersecting vehicle of which a traveling direction is a direction intersecting the traveling direction of the subject vehicle is present at a position of the predetermined point related to the extending direction of the road by the recognizer, the driving controller is configured to cause the control of the speed or the steering of the subject vehicle to be different.

According to an aspect of (4), in the vehicle control device according to any one aspect of (1) to (3), the driving controller is configured to further cause the control of the speed or the steering of the subject vehicle to be different between a case where the recognizer recognizes the predetermined point when the subject vehicle is traveling in a first section including the predetermined point among a plurality of sections included in a map indicated by the map information and a case where the recognizer recognizes the predetermined point when the subject vehicle is traveling in a second section that does not include the predetermined point.

According to an aspect of (5), in the vehicle control device according to an aspect of (4), in a case where the subject vehicle is traveling in the first section, the driving controller is configured to increase the degree of the control of the speed and the steering of the subject vehicle as compared with a case where the subject vehicle is traveling in the second section.

According to an aspect of (6), in the vehicle control device according to any one aspect of (1) to (5), a predictor that is configured to predict that an intersection intersecting the road is present at a position of the predetermined point related to an extending direction of the road in a case where the recognizer recognizes the predetermined point is further provided. In a case where it is predicted that the intersection is present by the predictor, the driving controller is configured to cause the control of the speed or the steering of the subject vehicle to be different.

According to an aspect of (7), in the vehicle control device according to any one aspect of (1) to (6), a map information updater that is configured to determine whether or not a route along which another vehicle having passed the predetermined point enters is present on a map indicated by the map information in a case where the other vehicle passing through the predetermined point is recognized by the recognizer, and updates the map information in a case where it is determined that the route along which the other vehicle passes the predetermined point is not present on the map is further provided.

According to an aspect of (8), a vehicle control method is configured to cause an in-vehicle computer to recognize a surrounding situation of a subject vehicle, control a speed and steering of the subject vehicle according to map information including a travel route of the subject vehicle and the recognized surrounding situation of the subject vehicle, and cause the control of the speed or the steering of the subject vehicle to be different between a case where a predetermined point at which a median strip is broken is recognized and a case where the predetermined point is not recognized, while the subject vehicle is traveling in a section in which a lane is separated by the median strip extending in an extending direction of a road indicated by the map information.

According to an aspect of (9), a computer-readable non-transitory storage medium storing a program that is configured to cause an in-vehicle computer to execute a process of recognizing a surrounding situation of a subject vehicle, a process of controlling a speed and steering of the subject vehicle according to map information including a travel route of the subject vehicle and the recognized surrounding situation of the subject vehicle, and a process of causing the control of the speed or the steering of the subject vehicle to be different between a case where a predetermined point at which a median strip is broken is recognized and a case where the predetermined point is not recognized, while the subject vehicle is traveling in a section in which a lane is separated by the median strip extending in an extending direction of a road indicated by the map information.

According to any aspect of (1) to (9), it is possible to copy with a change of a surrounding situation of a subject vehicle.

### BRIEF DESCRIPTION OF THE DRAWINGS

FIG. 1 is a constitution diagram of a vehicle system using a vehicle control device according to a first embodiment.

FIG. 2 is a diagram showing an example of a map indicated by second map information.

FIG. 3 is a functional constitution diagram of a first controller and a second controller.

FIG. 4 is a flowchart showing an example of a flow of a series of processes by an automatic driving control device according to the first embodiment.

FIG. 5 is a diagram showing an example of a scene in which a specific oncoming vehicle is present.

FIG. 6 is a diagram showing an example of a scene in which an intersecting vehicle is present.

FIG. 7 is a diagram showing an example of a scene in which an intersection is present.

FIG. 8 is a diagram showing an example of a control degree in each road section of a route on a map.

FIG. 9 is a functional constitution diagram of the first controller according to a fourth embodiment.

FIG. 10 is a diagram schematically showing an aspect of update of the map information.

FIG. 11 is a diagram showing an example of a hardware constitution of an automatic driving control device according to an embodiment.

### DESCRIPTION OF EMBODIMENTS

Hereinafter, embodiments of a vehicle control device, a vehicle control method, and a storage medium of the present invention will be described with reference to the drawings. A case where left-side driving is applied to the present invention will be described below, but in a case where right-side is applied to the present invention, it is only necessary to reverse left and right.

### First Embodiment

[Overall Constitution]

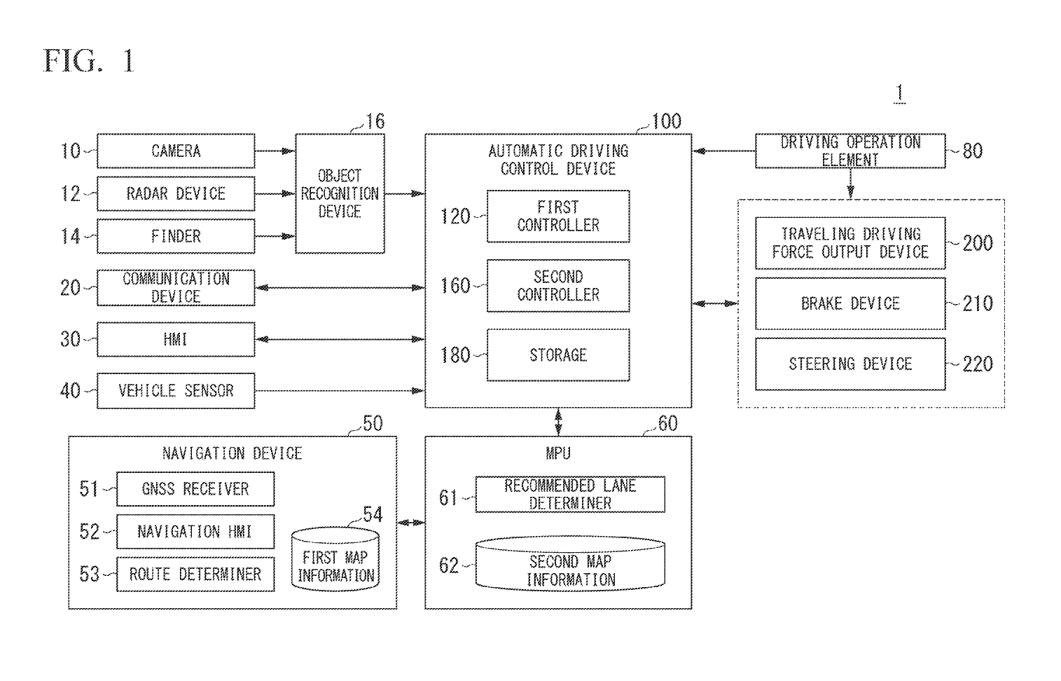

FIG. 1 is a constitution diagram of a vehicle system 1 using the vehicle control device according to a first embodiment. A vehicle (hereinafter, referred to as a subject vehicle M) in which the vehicle system 1 is mounted is, for example, a vehicle such as a two-wheeled vehicle, a three-wheeled vehicle, or a four-wheeled vehicle, and a driving source of the vehicle includes an internal combustion engine such as a diesel engine or a gasoline engine, an electric motor, or a combination thereof. The electric motor operates using electric power generated by a generator connected to the internal combustion engine, or discharge power of a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map positioning unit (MPU) 60, a driving operation element 80, an automatic driving control device 100, a traveling driving force output device 200, a brake device 210, and a steering device 220. Such devices and instruments are connected to each other by a multiplex communication line such as a controller area network (CAN) communication line, a serial communication line, a wireless communication network, or the like. The constitution shown in FIG. 1 is merely an example, and a part of the constitution may be omitted or other constitutions may be further added.

For example, the camera 10 is a digital camera using a solid imaging element such as a charge coupled device (CCD) or a complementary metal oxide semiconductor (CMOS). The camera 10 is attached to an arbitrary place on the subject vehicle M. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. The radar device 12 is attached to an arbitrary place on the subject vehicle M. The radar device 12 may detect the position and the speed of the object by a frequency modulated continuous wave (FM-CW) method.

The finder 14 is a light detection and ranging (LIDAR) device. The finder 14 irradiates light around the subject vehicle M and measures scattered light. The finder 14 determines the distance to the object on the basis of a time from light emission to light reception. For example, the irradiated light is laser light of a pulse shape. The finder 14 is attached to an arbitrary place on the subject vehicle M.

The object recognition device 16 performs a sensor fusion process on a detection result of some or all of the camera 10, the radar device 12, and the finder 14 to recognize a position, a type, a speed, and the like of the object. The object recognition device 16 outputs a recognition result to the automatic driving control device 100. The object recognition device 16 may output the detection result of the camera 10, the radar device 12, and the finder 14 as they are to the automatic driving control device 100. The object recognition device 16 may be omitted from the vehicle system 1.

For example, the communication device 20 communicates with another vehicle near the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like.

For example, the navigation device 50 includes a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40.

The navigation HMI 52 includes a display device, a speaker, a touch panel, a key, and the like. A part or all of the navigation HMI 52 may be shared with the above-described HMI 30.

For example, the route determiner 53 determines a route (hereinafter referred to as a route on a map) from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route on the map is output to the MPU 60.

The navigation device 50 may perform route guidance using the navigation HMI 52 on the basis of the route on the map. For example, the navigation device 50 may be realized by a function of a terminal device such as a smartphone or a tablet terminal possessed by the user. The navigation device 50 may transmit a current position and a destination to a navigation server through the communication device 20 and acquire the same route as the route on the map from the navigation server.

For example, the MPU 60 includes a recommended lane determiner 61 and holds second map information 62 in the storage device such as an HDD or a flash memory. The recommended lane determiner 61 divides the route on the map provided from the navigation device 50 into a plurality of blocks (for example, divides the route into intervals of 100 [m] in a vehicle traveling direction), and determines a recommended lane for each block by referring to the second map information 62. The recommended lane determiner 61 determines the number of a lane from the left that the vehicle is traveling in. In a case where there is a branching position on the route on the map, the recommended lane determiner 61 determines the recommended lane so that the subject vehicle M is able to travel on a reasonable travel route for progressing to a branch destination.

The second map information 62 is map information with higher accuracy than the first map information 54. For example, the second map information 62 may include information on the center of the lane, information on the boundary of the lane, information on the type of the lane, and the like. The second map information 62 may include road information, traffic regulation information, address information (an address and a postal code), facility information, telephone number information, and the like. The second map information 62 may be updated at any time by the communication device 20 communicating with another device.

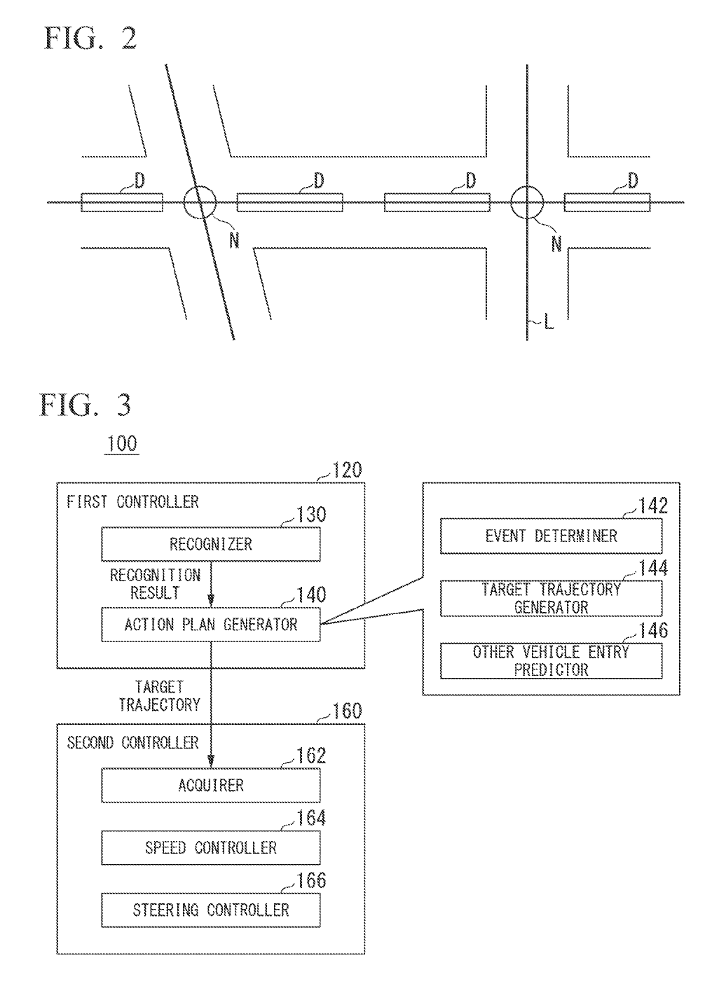

FIG. 2 is a diagram showing an example of a map indicated by the second map information 62. As shown in the shown example, the map indicated by the second map information 62 may be expressed by a link L representing each section of the road and a node N representing an intersection point where two or more road sections intersect with each other. Such a map may include a disposition arrangement position of a structure provided on a road such as a median strip D. The median strip D is a structure extending along a direction in which the road extends, and separates a lane as an outward road and a lane as a return lane.

In FIG. 1, the driving operation element 80 includes, for example, an acceleration pedal, a brake pedal, a shift lever, a steering wheel, a modified steering wheel, a joystick, and other operation elements. A sensor that detects the operation amount or presence or absence of an operation is attached to the driving operation element 80, and a detection result of the sensor is output to a part or all of the automatic driving control device 100, or the traveling driving force output device 200, the brake device 210, and the steering device 220.

For example, the automatic driving control device 100 includes a first controller 120, a second controller 160, and a storage 180. For example, the first controller 120 and the second controller 160 are realized by a processor such as a central processing unit (CPU) or a graphics processing unit (GPU) executing a program (software). Some or all of such constitution elements may be realized by hardware (a circuit unit including a circuitry) such as a large scale integration (LSI), an application specific integrated circuit (ASIC), or a field-programmable gate array (FPGA), or may be realized by software and hardware in cooperation. The program may be stored in the storage 180 of the automatic driving control device 100 in advance. Alternatively, the program may be stored in a detachable storage medium such as a DVD or a CD-ROM and may be installed in the storage 180 by attachment of the storage medium to a drive device.

The storage 180 is realized by, for example, an HDD, a flash memory, an electrically erasable programmable read only memory (EEPROM), a read only memory (ROM), a random access memory (RAM), or the like. The storage 180 stores, for example, a program read and executed by the processor.

FIG. 3 is a functional constitution diagram of the first controller 120 and the second controller 160. For example, the first controller 120 includes a recognizer 130 and an action plan generator 140. For example, the first controller 120 realizes a function of artificial intelligence (AI) and a function of a previously given model in parallel. For example, a function of “recognizing an intersection” is executed in parallel with recognition of an intersection by deep learning or the like and recognition based on a previously given condition (there is a pattern matching signal, a road sign, or the like) and may be realized by giving scores to both sides and comprehensively evaluating the scores. Therefore, reliability of automatic driving is guaranteed.

The recognizer 130 recognizes an object that is present in the vicinity of the subject vehicle M on the basis of the information input from the camera 10, the radar device 12, and the finder 14 through the object recognition device 16. The object recognized by the recognizer 130 includes, for example, a four-wheeled vehicle, a two-wheeled vehicle, a pedestrian, a median strip, a road sign, a road mark, a lane marking, a utility pole, a guardrail, a falling object, and the like. The recognizer 130 recognizes a state of the object, such as a position, a speed, an acceleration, or the like. For example, the position of the object is recognized as a position on an absolute coordinate (that is, a relative position with respect to the subject vehicle M) using a representative point (center of gravity, driving axis center, or the like) of the subject vehicle M as an origin and is used for control. The position of the object may be represented by a representative point such as a center of gravity or a corner of the object, or may be represented by an expressed region. The “state” of the object may include an acceleration or jerk of the object, or “behavioral state” (for example, the object changes a lane or whether or not the object is about to change the lane).

For example, the recognizer 130 recognizes a subject lane in which the subject vehicle M is traveling and an adjacent lane adjacent to the subject lane. For example, the recognizer 130 recognizes the subject lane or the adjacent lane by comparing a pattern of a road lane marking (for example, an arrangement of a solid line and a broken line) obtained from the second map information 62 with a pattern of a road lane marking near the subject vehicle M recognized from the image captured by the camera 10.

The recognizer 130 may recognize the subject lane or the adjacent lane by recognizing a traveling road boundary (a road boundary) including a road lane marking, a road shoulder, a curb, a median strip, a guardrail, and the like, and is not limited to recognizing road lane markings. In this recognition, the position of the subject vehicle M acquired from the navigation device 50 or a process result by an INS may be added. The recognizer 130 recognizes a temporary stop line, an obstacle, a red light, a toll gate, and other road events.

When recognizing the subject lane, the recognizer 130 recognizes the relative position and a posture of the subject vehicle M with respect to the subject lane. For example, the recognizer 130 may recognize an angle formed by a deviation of a reference point of the subject vehicle M from a center of the lane and a line connecting the center of the lane of a traveling direction of the subject vehicle M as a relative position and the posture of the subject vehicle M with respect to the subject lane. Instead of this, the recognizer 130 may recognize a position of the reference point of the subject vehicle M with respect to one of side end portions (the road lane marking or the road boundary) of the subject lane as the relative position of the subject vehicle M with respect to the subject lane.

The action plan generator 140 includes, for example, an event determiner 142, a target trajectory generator 144, and an other vehicle entry predictor 146. The event determiner 142 determines an automatic driving event on the route on which the recommended lane is determined. The event is information that prescribes a traveling mode of the subject vehicle M.

The event includes, for example, a constant-speed traveling event in which the subject vehicle M is caused to travel on the same lane at a constant speed, a follow-up traveling event in which the subject vehicle M is caused to follow the other nearby vehicle (hereinafter, referred to as a preceding vehicle) that is present within a predetermined distance (for example, within 100 [m]) in front of the subject vehicle M, a lane change event in which the subject vehicle M is caused to change the lane from the subject lane to the adjacent lane, a branch event in which the subject vehicle M is caused to branch to a target lane at a branch point of a road, a confluence event in which the subject vehicle M is caused to join to a main line at a confluence point, a takeover event for ending the automatic driving and switching to the manual driving, and the like. For example, the “following” may be a traveling mode in which an inter-vehicle distance (relative distance) between the subject vehicle M and the preceding vehicle is kept constant, or may be a traveling mode in which the inter-vehicle distance between the subject vehicle M and the preceding vehicle is kept constant and the subject vehicle M is caused to travel at a center of the subject lane. For example, the event may include an overtaking event in which the subject vehicle M is caused to change the lane to the adjacent lane, overtake the preceding vehicle in the adjacent lane, and change the lane to an original lane again, or in which the subject vehicle M is caused to be close to a lane marking defining the subject lane without changing the lane to the adjacent lane, overtake the preceding vehicle within the same lane, and return the subject vehicle M to an original position (for example, a lane center), and an avoidance event in which the subject vehicle is caused to perform at least one of braking and steering so as to avoid an obstacle that is present in front of the subject vehicle M, and the like.

For example, the event determiner 142 may change an event that has already been determined for a current section to another event in accordance with a surrounding situation recognized by the recognizer 130 when the subject vehicle M is traveling, or may determine a new event for the current section.

In principle, the target trajectory generator 144 generates a future target trajectory that causes the subject vehicle M to travel automatically (without depending on the operation of the driver) in the traveling mode prescribed by the event, in order to cope with the surrounding situation when the subject vehicle M is traveling on the recommended lane determined by the recommended lane determiner 61 and the subject vehicle M further is traveling the recommended lane. The target trajectory includes, for example, a position element that defines a future position of the subject vehicle M, and a speed element that defines a future speed of the subject vehicle M, and the like.

For example, the target trajectory generator 144 determines a plurality of points (trajectory points) to which the subject vehicle M should sequentially reach as the position element of the target trajectory. The trajectory point is a point to which the subject vehicle M should reach for each predetermined traveling distance (for example, about several [m]). The predetermined traveling distance may be calculated, for example, by a road distance when traveling along the route.

The target trajectory generator 144 determines a target speed and a target acceleration for each predetermined sampling time (for example, about 0 comma [sec]) as the speed element of the target trajectory. The trajectory point may be a position to which the subject vehicle M should reach at a sampling time for each predetermined sampling time. In this case, the target speed and the target acceleration are determined by the sampling time and an interval between the trajectory points. The target trajectory generator 144 outputs information indicating the generated target trajectory to the second controller 160.

The other vehicle entry predictor 146 predicts that another vehicle that is present outside the subject lane enters in front of the subject vehicle M on the subject lane on the basis of a recognition result of the recognizer 130 and the second map information 62 (or the first map information 54). A specific prediction process by other vehicle entry predictor 146 will be described later.

When it is predicted that another vehicle enters the subject lane by the other vehicle entry predictor 146, the above-described event determiner 142 changes the event determined for the current section in which the subject vehicle M is traveling to another event, the target trajectory generator 144 newly generates a target trajectory corresponding to the changed event.

The second controller 160 controls the traveling driving force output device 200, the brake device 210, and the steering device 220 so that the subject vehicle M passes through the target trajectory generated by the target trajectory generator 144 at a scheduled time.

For example, the second controller 160 includes an acquirer 162, a speed controller 164, and a steering controller 166. A combination of the event determiner 142, the target trajectory generator 144, and the second controller 160 is an example of a “driving controller”.

The acquirer 162 acquires information on the target trajectory (a trajectory point) generated by the target trajectory generator 144 and stores the information on the target trajectory in a memory of the storage 180.

The speed controller 164 controls one or both of the traveling driving force output device 200 and the brake device 210 on the basis of the speed element (for example, target speed, target acceleration, or the like) included in the target trajectory that is stored in the memory.

The steering controller 166 controls the steering device 220 according to the position element (for example, curvature representing a degree of curvature of the target trajectory) included in the target trajectory that is stored in the memory. Hereinafter, control of one or both of the traveling driving force output device 200, the brake device 210, and the steering device 220 will be referred to as “automatic driving”.

For example, a process of the speed controller 164 and the steering controller 166 is realized by a combination of feed-forward control and feedback control. As an example, the steering controller 166 is executed by a combination of feed-forward control according to a curvature of the road ahead of the subject vehicle M and feedback control based on the deviation from the target trajectory.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and a power electronic controller (ECU) that controls the internal combustion engine, the electric motor, the transmission, and the like. The power ECU controls the above-described constitutions according to the information input from the second controller 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the second controller 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the second controller 160 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the second controller 160 or the information input from the driving operation element 80.

[Process Flow]

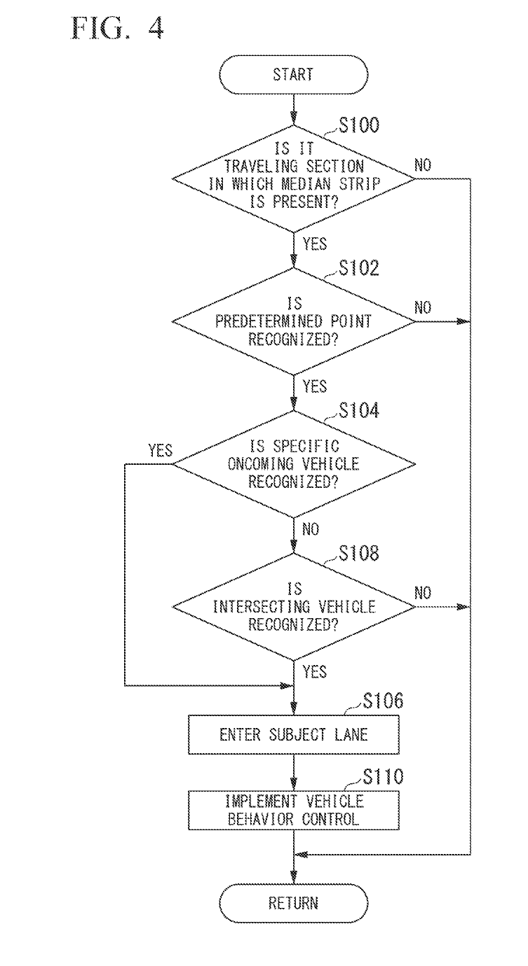

Hereinafter, a flow of a series of processes by the automatic driving control device 100 of the first embodiment will be described with reference to a flowchart. FIG. 4 is a flowchart showing an example of a flow of a series of processes by the automatic driving control device 100 according to the first embodiment. The process of the present flowchart may be repeatedly executed at a predetermined period.

First, the other vehicle entry predictor 146 determines whether or not the road section in which the subject vehicle M is currently traveling is the section in which the lane is separated by the median strip D on the basis of the current position of the subject vehicle M specified by the navigation device 50 and the second map information 62 (step S100).

In a case where the other vehicle entry predictor 146 determines that the road section in which the subject vehicle M is currently traveling is the section in which the lane is separated by the median strip D, the other vehicle entry predictor 146 determines whether or not a predetermined point P is recognized by the recognizer 130 (step S102). The predetermined point P is a point where the median strip D extending in the extending direction of the road is broken in the extending direction.

In a case where the other vehicle entry predictor 146 determines that the road section in which the subject vehicle M is currently traveling is the section in which the lane is separated by the median strip D, and further in a case where it is determined that the predetermined point P is recognized by recognizer 130, that is, in a case where, although the section in which the subject vehicle M is currently traveling is expressed as the section in which the lane is separated by the median strip D on the map indicated by the second map information 62 or the first map information 54, a point where a part of the lane is not separated by the median strip D is present in an actual traveling environment recognized by the recognizer 130 using a sensor or the like, the other vehicle entry predictor 146 further determines whether or not it is recognized that a specific oncoming vehicle is present on an opposite lane adjacent to the subject lane (step S104) through the median strip D by the recognizer 130.

The specific oncoming vehicle is an oncoming vehicle that expresses intention to change the lane to a side of the subject lane on the opposite lane. For example, the specific oncoming vehicle is an oncoming vehicle that operates a turn signal lamp on the left as viewed from the subject vehicle M (a turn lamp on the right as viewed from the oncoming vehicle), among a plurality of turn signal lamps (turn lamps) provided on the oncoming vehicle.

In a case where it is recognized that the specific oncoming vehicle is present on the opposite lane by the recognizer 130, the other vehicle entry predictor 146 predicts that the specific oncoming vehicle will enter the subject lane from the opposite lane (step S106).

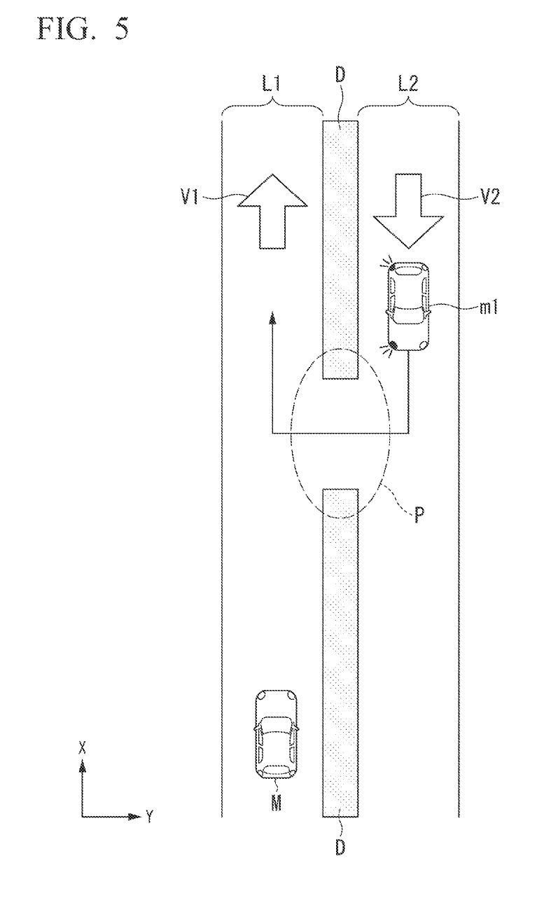

FIG. 5 is a diagram showing an example of a scene in which the specific oncoming vehicle is present. In the figure, L1 represents the subject lane on which the subject vehicle M is present among the lanes separated by the medial strip D, L2 represents the opposite lane on which the oncoming vehicle is traveling of which a progress direction is an opposite direction V2 with respect to a traveling direction V1 of the vehicle traveling on the subject lane L1. In the shown scene, the predetermined point P where a part of the median strip D is broken is present.

In the scene of the shown example, the turn signal lamp on the right side of the oncoming vehicle ml is operated (turned on or caused to blink) and the vehicle starts to make a U-turn in front of the predetermined point P (in front of the predetermined point P viewed from the oncoming vehicle ml). In such a scene, the recognizer 130 recognizes the predetermined point P and recognizes the oncoming vehicle ml in the vicinity of the predetermined point P as the specific oncoming vehicle. Therefore, the other vehicle entry predictor 146 predicts that the specific oncoming vehicle will enter the subject lane L1 from the opposite lane L2 in order to make a U-turn.

In FIG. 4, in a case where it is not recognized that the specific oncoming vehicle is present in the opposite lane by the recognizer 130, the other vehicle entry predictor 146 determines whether or not the presence of an intersecting vehicle is recognized by the recognizer 130 (step S108). The intersecting vehicle is another vehicle of which a progress direction is a direction intersecting the traveling direction of the subject vehicle M. For example, the intersecting vehicle includes a vehicle parked in a parking lot facing the road including the subject lane, or a vehicle that is present at an intersection intersecting the road including the subject lane. The direction intersecting the progress direction of the subject vehicle M is, for example, a direction in which an angle formed by the progress direction of the subject vehicle M falls within an angular range of 90[°] plus or minus about 70[°].

In a case where it is recognized that the intersecting vehicle is present by the recognizer 130, the other vehicle entry predictor 146 predicts that the intersecting vehicle will enter the subject lane as the process of S106.

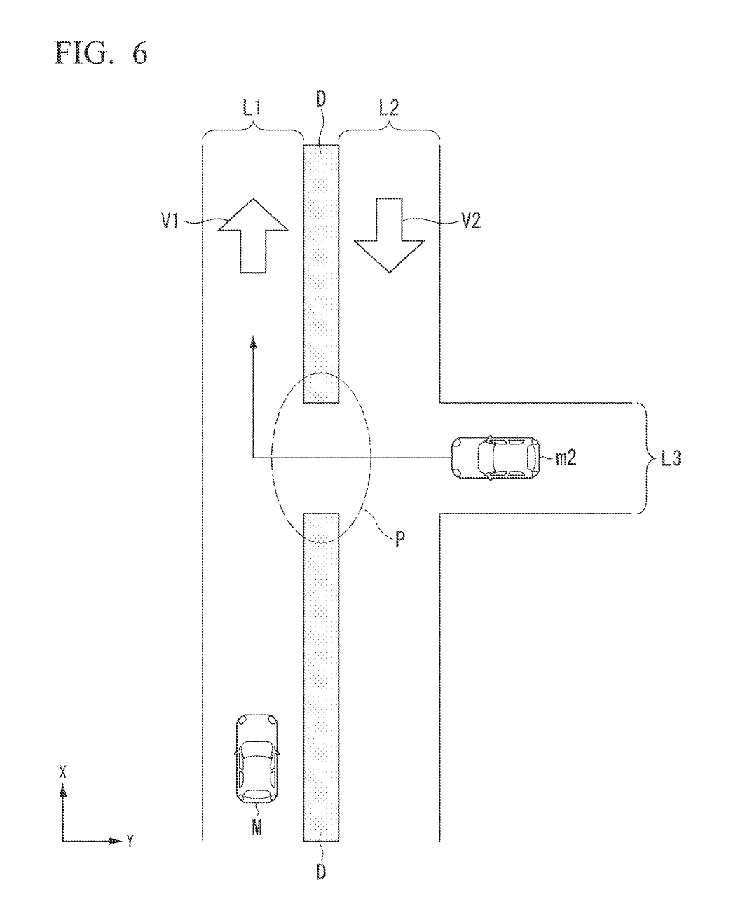

FIG. 6 is a diagram showing an example of a scene in which the intersecting vehicle is present. In the figure, L3 represents the intersection intersecting the opposite lane L2. In the shown example, another vehicle m2 is present in the intersection L3. In such a scene, the recognizer 130 recognizes the other vehicle m2 as the intersecting vehicle. In a case where the intersecting vehicle is recognized by the recognizer 130, the other vehicle entry predictor 146 determines whether or not the predetermined point P is present on an extension line of the progress direction of the intersecting vehicle, and in a case where the predetermined point P is present on the extension line of the progress direction of the intersecting vehicle, since there is a possibility that the intersecting vehicle will go straight and cross the opposite lane L2 and enter the subject lane L1 from the predetermined point P, the other vehicle entry predictor 146 predicts that the intersecting vehicle will enter the subject lane L1. In the shown example, it is described that the intersecting vehicle is the vehicle that is present on the intersection L3 intersecting the opposite lane L2, but the intersecting vehicle is not limited thereto, and the intersecting vehicle may be a vehicle that is present on an intersection intersecting the subject lane, in a parking lot, or the like that is provided along the subject lane.

In FIG. 4, next, in a case where it is predicted that the specific oncoming vehicle will enter the subject lane from the opposite lane or in a case where it is predicted the intersecting vehicle will enter the subject lane, the automatic driving control device 100 performs predetermined vehicle behavior control (step S110). The predetermined vehicle behavior control is control of a speed or steering of the subject vehicle M in consideration of the other vehicle (the specific oncoming vehicle or the intersecting vehicle) entering (interrupting) the subject lane. The predetermined vehicle behavior control causes the control of one or both of the speed and the steering to be different in a case where it is predicted that the specific oncoming vehicle will enter the subject lane from the opposite lane or a case where it is predicted that the intersecting vehicle will enter the subject lane, and a case where it is not predicted that the specific oncoming vehicle will enter the subject lane from the opposite lane or a case where it is not predicted that the intersecting vehicle will enter the subject lane. For example, the predetermined vehicle behavior control includes one or both of speed control for keeping an inter-vehicle distance between the subject vehicle M and the other vehicle constant, and steering control for causing the vehicle M to move away from the other vehicle in a vehicle width direction. More specifically, the predetermined vehicle behavior control includes further controlling an acceleration of the subject vehicle M, decelerating the subject vehicle M, causing the subject vehicle M to move closer to a lane marking partitioning the subject lane, and causing the subject vehicle M to cross the lane marking and change the lane to an adjacent lane.

For example, in a case where the other vehicle entry predictor 146 predicts that the specific oncoming vehicle or the intersecting vehicle will enter the subject lane, the event determiner 142 changes the current event to the avoidance event in which the other vehicle that has entered in the subject lane is set as an obstacle. In response to this, for example, in order to keep the inter-vehicle distance between the subject vehicle M and the intersecting vehicle, the target trajectory generator 144 generates a target trajectory including a target speed for decelerating the subject vehicle M as a speed element or a target trajectory including a trajectory point disposed on a side of the lane marking as a position element, as a target trajectory corresponding to the avoidance event. The second controller 160 controls a part or all of the traveling driving force output device 200, the brake device 210, and the steering device 220 on the basis of the target trajectory corresponding to the avoidance event, so as to perform the predetermined vehicle behavior control of further controlling an acceleration of the subject vehicle M, decelerating the subject vehicle M, or causing the subject vehicle M to move closer to the lane marking.

In a case where another lane in which the progress direction of the vehicle is the same as the subject lane is present as the adjacent lane of the subject lane, instead of changing the current event to the avoidance event, the event determiner 142 may change the current event to an overtaking event or the lane change event for the purpose of moving the subject vehicle M to the adjacent lane. In a case where it is not predicted that the specific oncoming vehicle or the intersecting vehicle will enter the subject lane by the other vehicle entry predictor 146, the event determiner 142 may maintain the current event without changing the current event. In this case, the second controller 160 does not perform the predetermined vehicle behavior control under an assumption that the specific oncoming vehicle or the intersecting vehicle enters the subject lane, and causes the subject vehicle M to be automatically driven in a traveling mode of the current event. Therefore, the process of the present flowchart is ended.

According to the first embodiment described above, the automatic driving control device 100 recognizes the surrounding situation of the subject vehicle M, controls the speed and the steering of the subject vehicle on the basis of the map information including the traveling route of the subject vehicle M and the recognized surrounding situation of the subject vehicle M, and performs the predetermined vehicle behavior control for causing the control of the speed or the steering to be different between a case where the predetermined point P at which the median strip D is broken is recognized and a case where the predetermined point P at which the median strip D is broken is not recognized, while the subject vehicle M is traveling the section in which the lane is separated by the median strip D extending in the extending direction of the road among a plurality of sections included in the map indicated by the map information. Therefore, it is possible to cope with a change of the surrounding situation of the subject vehicle M.

### Second Embodiment

Hereinafter, a second embodiment will be described. In the first embodiment described above, it has been described that the predetermined vehicle behavior control is not performed in a case where it is not predicted that the specific oncoming vehicle or the intersecting vehicle will enter the subject lane. On the other hand, the second embodiment is different from the first embodiment described above in that even in a case where it is not predicted that the specific oncoming vehicle or the intersecting vehicle will enter the subject lane, in a case where the predetermined point P is recognized in front of the subject vehicle M, the predetermined vehicle behavior control is performed. Hereinafter, the differences from the first embodiment will be mainly described, and descriptions of functions and the like in common with the first embodiment will be omitted.

In a case where the predetermined point P is recognized in front of the subject vehicle M by the recognizer 130, the other vehicle entry predictor 146 in the second embodiment predicts that the intersecting vehicle is present at a point at which the intersection is intersecting the road or at the intersection, at the position related to the extending direction of the road of the predetermined point P.

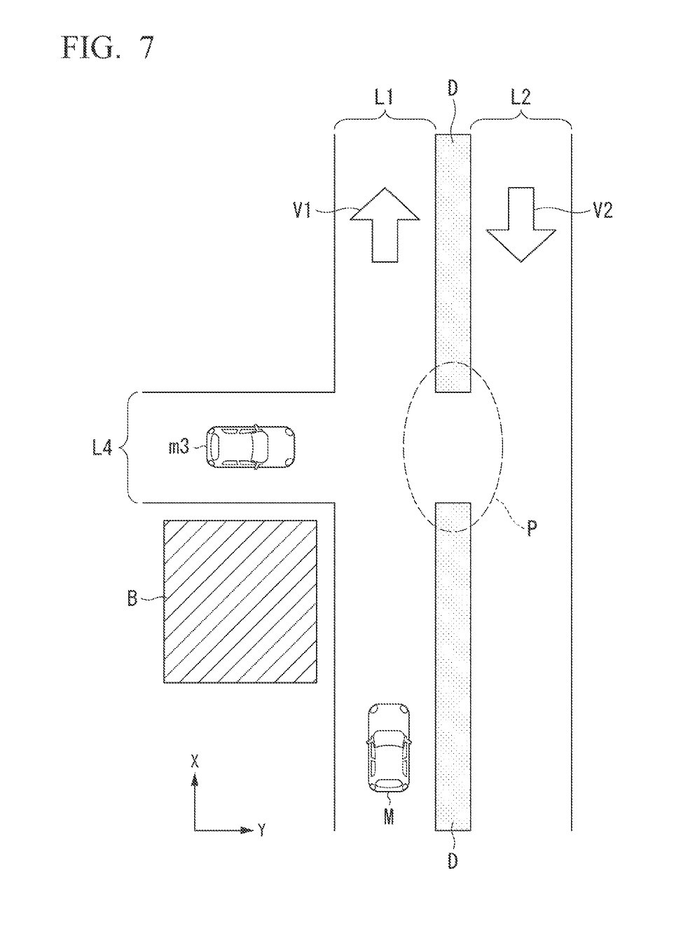

FIG. 7 is a diagram showing an example of a scene in which the intersection is present. In the figure, L4 represents the intersection intersecting the subject lane L1 and B represents a shielding object (for example, a building or the like) that covers a vehicle traveling on the intersection L4 as viewed from the subject vehicle M. As in the scene of the shown example, in a case where the shielding object B is present, the intersection L4 is a blind spot when viewed from the subject vehicle M, and the intersection L4 itself may not be recognized by the recognizer 130. Even in a case where the intersection L4 is recognized by the recognizer 130, an intersecting vehicle m3 may not be recognized by the recognizer 130 even though the intersecting vehicle m3 is present in the intersection L4 because the shielding object B is present in some cases. As in the scene shown in FIG. 6, since there is a possibility that the intersecting vehicle m3 may go straight from the intersection L4 and cross the subject vehicle lane L1 and enter the opposite lane L2 from the predetermined point P, even though the intersection or the intersecting vehicle is not recognized, in a case where the predetermined point P is recognized, the other vehicle entry predictor 146 according to the second embodiment predicts that the intersection is present at a position Xₚ of the predetermined point P related to the extending direction (X direction in the figure) of the road and predicts that the intersecting vehicle is present at the intersection. Therefore, the automatic driving control device 100 according to the second embodiment is able to perform the predetermined vehicle behavior control under an assumption of the intersecting vehicle hidden in the blind spot of the shielding object B.

According to the second embodiment described above, even in a case where it is not predicted that the specific oncoming vehicle or the intersecting vehicle will enter the subject lane, in a case where the predetermined point P is recognized in front of the subject vehicle M, since the predetermined vehicle behavior control is performed, it is possible to cope with the surrounding situation in which the intersecting vehicle is hidden in the blind spot of the shielding object B.

### Third Embodiment

Hereinafter, a third embodiment will be described. The third embodiment is different from the first and second embodiments described above in that a control degree of the speed or the steering of the controlled subject vehicle M is caused to be different as the predetermined vehicle behavior control, between a first section in which the predetermined point P is present and a second section in which the predetermined point P is not present, among a plurality of road sections that divide a route on the map representing a route to a destination of the subject vehicle M on the map indicated by the second map information 62. The control degree of the speed represents, for example, the degree when changing a speed, an acceleration, or the like of the subject vehicle M, and the control degree of the steering represents, for example, a degree when changing a direction of steerable wheels. Hereinafter, differences from the first and second embodiments will be mainly described, and a description of functions and the like common to the first and second embodiments will be omitted.

For example, in a case where it is predicted that the specific oncoming vehicle or the intersecting vehicle will enter the subject lane by the other vehicle entry predictor 146 when the subject vehicle M is traveling in the first section (hereinafter referred to as a case of a condition A), the action plan generator 140 according to the third embodiment increases the control degree of the speed or the steering of the subject vehicle M as compared with a case where it is predicted that the specific oncoming vehicle or the intersecting vehicle will enter the subject lane by the other vehicle entry predictor 146 when the subject vehicle M is traveling in the second section (hereinafter referred to as a case of a condition B).

More specifically, the target trajectory generator 144 according to the third embodiment reduces the target speed or the target acceleration included in the target trajectory as the speed element, or disposes the trajectory point included in the target trajectory as the position element at a position closer to the lane marking. By generating such a target trajectory, in a case of a situation in which the predetermined point P is present in the recognition result even though the predetermined point P is not present in the map information, the automatic driving control device 100 according to the third embodiment further decelerates the subject vehicle M or is configured to cause the subject vehicle M to move closer to the side of the lane marking from a center of the subject lane. In a case of the condition A, the action plan generator 140 may shorten a period of a process such as an event change process and a target trajectory generation process, as compared with a case of the condition B. Therefore, the automatic driving control device 100 according to the third embodiment is able to start the predetermined vehicle behavior control at an earlier timing.

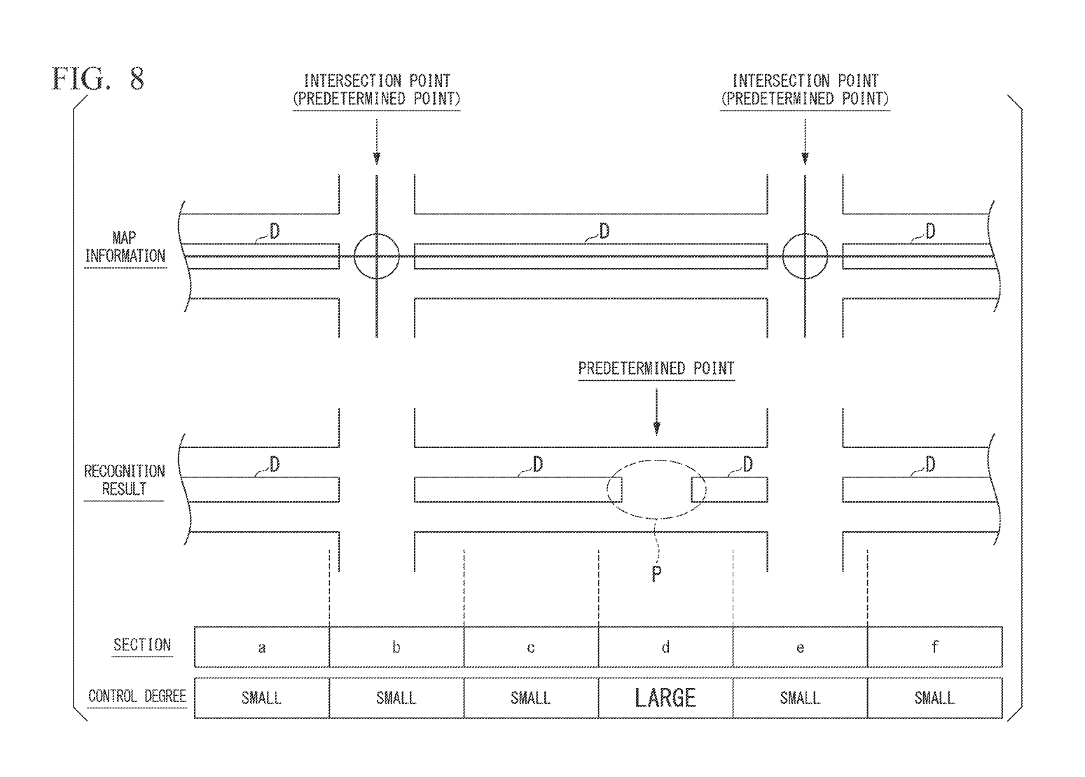

FIG. 8 is a diagram showing an example of the control degree in each road section of the route on the map. For example, in a case where road sections a to f are included in the route on the map, the action plan generator 140 changes the control degree for each road section. In the shown example, on the map, the median strip D extends in the extending direction of the road in the road sections a, c, d, and f, and the intersection points (examples of a predetermined point P at which the median strip D is broken) are present in the road sections b and e. On the other hand, in the recognition result by the recognizer 130, the predetermined point Pis present in the road section d. In such a case, the action plan generator 140 may increase the control degree for the road section d and reduce the control degree for the other road sections a, b, c, e, and f.

According to the third embodiment described above, in the first section in which the predetermined point P is present and in the second section in which the predetermined point P is not present, the control degree of the speed or the steering of the subject vehicle M, which perform control as predetermined vehicle behavior control, is caused to be different. Therefore, for example, in a case where the map information and the recognition result do not match with respect to the presence or absence of the predetermined point P, it is possible to further cope with the surrounding situation.

### Fourth Embodiment

Hereinafter, a fourth embodiment will be described. The fourth embodiment is different from the first to third embodiments described above in that, in a case where the predetermined point P is recognized and the other vehicle passing through the predetermined point P is also recognized, the first controller 120 updates the second map information 62 or the first map information 54. Hereinafter, the differences from the first to third embodiments will be mainly described, and descriptions of functions and the like in common with the first to third embodiments will be omitted.

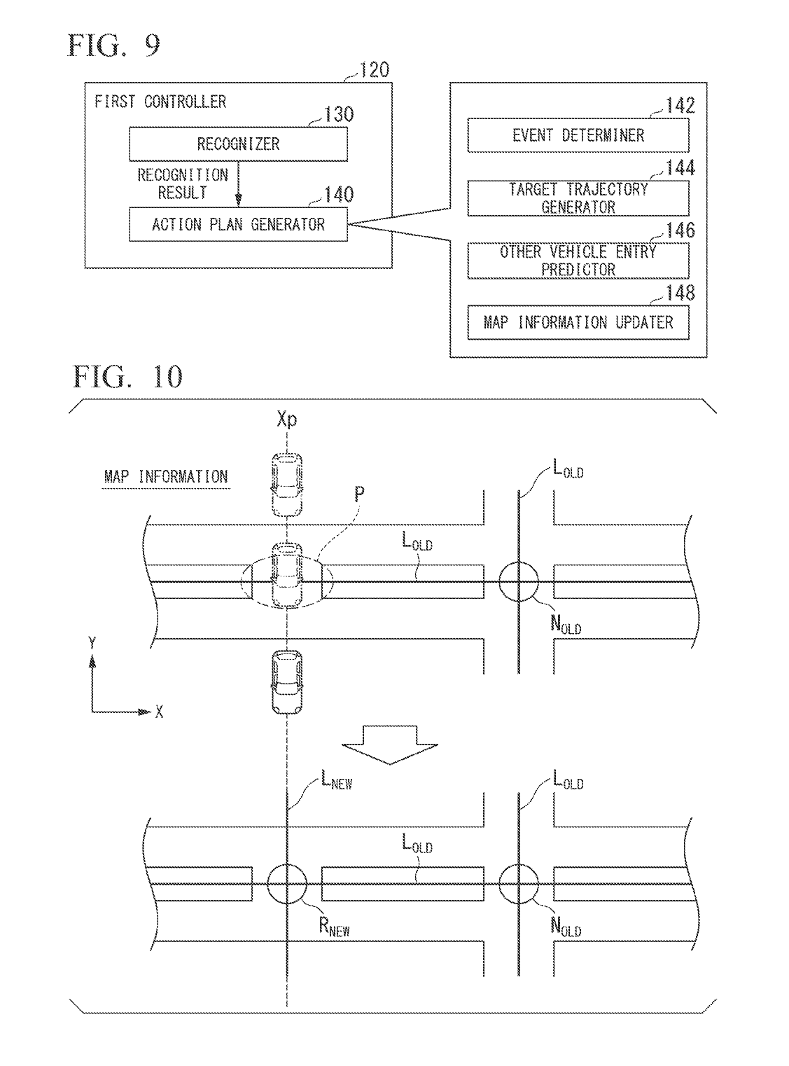

FIG. 9 is a functional constitution diagram of the first controller 120 according to the fourth embodiment. For example, the action plan generator 140 of the first controller 120 according to the fourth embodiment includes a map information updater (a map information update unit) 148, in addition to the event determiner 142, the target trajectory generator 144, and the other vehicle entry predictor 146 described above.

In a case where the predetermined point P is recognized and the other vehicle (the specific oncoming vehicle or the intersecting vehicle) passing through the predetermined point P and having entered the intersection is recognized by the recognizer 130, the map information updater 148 determines whether or not an intersection where the other vehicle has entered is present on the map indicated by the second map information 62 or the first map information 54. In a case where it is recognized that the other vehicle having passed through the predetermined point P has entered the intersection by the recognizer 130 even though the intersection is not present on the map, the map information updater 148 updates referenced map information.

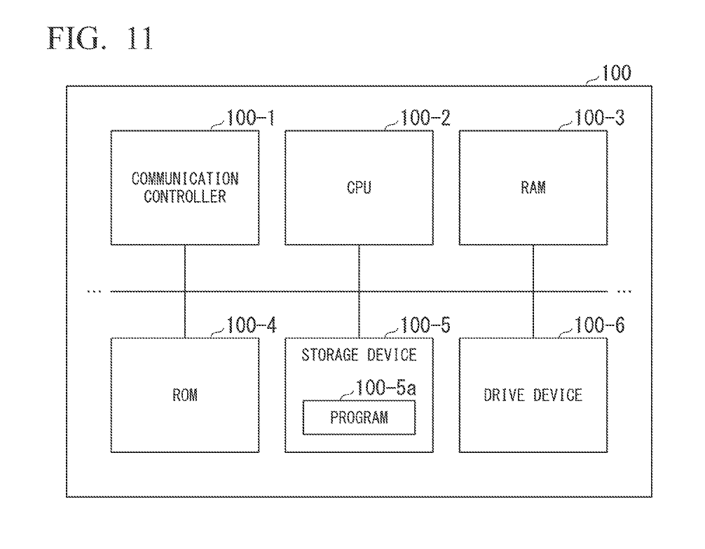

FIG. 10 is a diagram schematically showing an aspect of the update of the map information. In the shown example, the other vehicle having passed through the predetermined point P is progressing at a position where the intersection is not present on the map. In such a case, since a probability that the intersection intersects the road including the subject lane is high at a position Xp related to the extending direction of the road of the predetermined point P, the map information updater 148 determines whether or not a link representing the intersection is present at the position Xp on the map, and in a case where the link representing the intersection is not present, the map information updater 148 updates the map by adding a new link L to the position X_{P} on the map and adding a new node N_{NEW} at an intersection point with the existing link L_{OLD}.

According to the fourth embodiment described above, in a case where the other vehicle having passed through the predetermined point P enters the intersection or the like that is not present on the map, in order to update the map information, in a case where the next or subsequent updated map information is referred to, it is possible to more accurately predict that the specific oncoming vehicle or the intersecting vehicle will enter the subject lane. As a result, it is possible to perform the vehicle behavior control in closer correspondence with a change of the surrounding situation.

[Hardware Constitution]

FIG. 11 is a diagram showing an example of a hardware constitution of the automatic driving control device 100 according to an embodiment. As shown in the figure, the automatic driving control device 100 includes a constitution in which a communication controller 100-1, a CPU 100-2, a RAM 100-3 used as a working memory, a ROM 100-4 storing a boot program and the like, a storage device 100-5 such as a flash memory or an HDD, a drive device 100-6 and the like are mutually connected by an internal bus or a dedicated communication line. The communication controller 100-1 communicates with components other than the automatic driving control device 100. A program 100-5a executed by the CPU 100-2 is stored in the storage device 100-5. This program is developed in the RAM 100-3 by a direct memory access (DMA) controller (not shown) or the like and executed by the CPU 100-2. Therefore, a part or all of the first controller 120 and the second controller 160 are realized.

The above-described embodiment is able to be expressed as follows.

A vehicle control device including:

a storage that is configured to store a program; and

a processor,

wherein the processor is configured to execute the program to:

recognize a surrounding situation of a subject vehicle;

control a speed and steering of the subject vehicle based on map information including a travel route of the subject vehicle and the recognized surrounding situation of the subject vehicle; and

cause the control of the speed or the steering of the subject vehicle to be different between a case where a predetermined point at which a median strip is broken is recognized and a case where the predetermined point is not recognized, while the subject vehicle is traveling in a section in which a lane is separated by the median strip extending in an extending direction of a road indicated by the map information.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer that is configured to recognize a surrounding situation of a subject vehicle; and
a driving controller that is configured to control a speed and steering of the subject vehicle according to map information including a travel route of the subject vehicle and a recognition result by the recognizer,
wherein the driving controller is configured to cause the control of the speed or the steering of the subject vehicle to be different between a case where a predetermined point at which a median strip is broken is recognized by the recognizer and a case where the predetermined point is not recognized by the recognizer, while the subject vehicle is traveling in a section in which a lane is separated by the median strip extending in an extending direction of a road indicated by the map information.

2. The vehicle control device of claim 1,
wherein, in a case that the recognizer recognizes that one or more oncoming vehicles are present on an opposite lane adjacent to a subject lane through the median strip and it is recognized that a specific oncoming vehicle displaying an intention to change the lane from the opposite lane to the subject lane at the predetermined point among the one or more oncoming vehicles is present by the recognizer, the driving controller is configured to cause the control of the speed or the steering of the subject vehicle to be different.

3. The vehicle control device of claim 1,
wherein, in a case that the recognizer recognizes that an intersecting vehicle of which a traveling direction is a direction intersecting the traveling direction of the subject vehicle is present at a position of the predetermined point related to the extending direction of the road by the recognizer, the driving controller is configured to cause the control of the speed or the steering of the subject vehicle to be different.

4. The vehicle control device of claim 1,
wherein the driving controller further is configured to cause the control of the speed or the steering of the subject vehicle to be different between a case where the recognizer recognizes the predetermined point when the subject vehicle is traveling in a first section including the predetermined point among a plurality of sections included in a map indicated by the map information and a case where the recognizer recognizes the predetermined point when the subject vehicle is traveling in a second section that does not include the predetermined point.

5. The vehicle control device of claim 4,
wherein, in a case where the subject vehicle is traveling in the first section, the driving controller is configured to increase a degree of the control of the speed and the steering of the subject vehicle as compared with a case where the subject vehicle is traveling in the second section.

6. The vehicle control device of claim 1, further comprising:
a predictor that is configured to predict that an intersection intersecting the road is present at a position of the predetermined point related to an extending direction of the road in a case where the recognizer recognizes the predetermined point,
wherein, in a case where it is predicted that the intersection is present by the predictor, the driving controller is configured to cause the control of the speed or the steering of the subject vehicle to be different.

7. The vehicle control device of claim 1, further comprising:
a map information updater that is configured to determine whether or not a route along which another vehicle having passed the predetermined point enters is present on a map indicated by the map information in a case where the other vehicle passing through the predetermined point is recognized by the recognizer, and updates the map information in a case where it is determined that the route along which the other vehicle having passed the predetermined point enters is not present on the map.

8. A vehicle control method that is configured to cause an in-vehicle computer to:
recognize a surrounding situation of a subject vehicle;
control a speed and steering of the subject vehicle according to map information including a travel route of the subject vehicle and the recognized surrounding situation of the subject vehicle; and
cause the control of the speed or the steering of the subject vehicle to be different between a case where a predetermined point at which a median strip is broken is recognized and a case where the predetermined point is not recognized, while the subject vehicle is traveling in a section in which a lane is separated by the median strip extending in an extending direction of a road indicated by the map information.

9. A computer-readable non-transitory storage medium storing a program that is configured to cause an in-vehicle computer to execute:
a process of recognizing a surrounding situation of a subject vehicle;
a process of controlling a speed and steering of the subject vehicle according to map information including a travel route of the subject vehicle and the recognized surrounding situation of the subject vehicle; and
a process of causing the control of the speed or the steering of the subject vehicle to be different between a case where a predetermined point at which a median strip is broken is recognized and a case where the predetermined point is not recognized, while the subject vehicle is traveling in a section in which a lane is separated by the median strip extending in an extending direction of a road indicated by the map information.
